(19) United States
(12) Patent Application Publication
(10) Pub. No.: US 2010/0257499 A1
(43) Pub. Date: Oct. 7, 2010

(54) TECHNIQUES FOR FAST AREA-EFFICIENT INCREMENTAL PHYSICAL SYNTHESIS

(75) Inventors: Charles J. Alpert, Cedar Park, TX (US); Zhuo Li, Cedar Park, TX (US); Chin Ngai Sze, Austin, TX (US); Louise H. Trevillyan, Katonah, NY (US); Ying Zhou, Cedar Park, TX (US)

Correspondence Address: IBM CORPORATION;INTELLECTUAL PROPERTY LAW, 11501 BURNET ROAD, AUSTIN, TX, 78758, US

(73) Assignee: International Business Machines Corporation, Armonk, NY (US)

(21) Appl. No.: 12/416,960

(22) Filed: Apr. 2, 2009

(51) Int. Cl. G06F 17/50

(52) U.S. Cl. 716/6; 716/11

(57) ABSTRACT

A fast technique for circuit optimization in a physical synthesis flow iteratively repeats slew-driven (timerless) buffering and repowering with a changing slew target. Buffers are added as necessary with each iteration to bring the nets in line with the new slew target, but any nets having positive slack from the previous iteration are skipped, and that slack information is cached for future timing analysis. Buffer insertion is iteratively repeated with incrementally decreasing slew until a minimum slew is reached, or when none of the nets have negative slack. Iteratively repeating the timerless buffering and repowering while gradually decreasing the slew constraint in this manner results in a design structure which retains high quality of results with significantly smaller area and wire length, and with only a small computational overhead.

### BACKGROUND OF THE INVENTION

1. Field of the Invention

The present invention generally relates to the design of integrated circuits, and more particularly to a method for physical synthesis of an integrated circuit design using optimization, simulation and analysis tools.

2. Description of the Related Art

Integrated circuits are used for a wide variety of electronic applications, from simple devices such as wristwatches, to the most complex computer systems. A microelectronic integrated circuit (IC) chip can generally be thought of as a collection of logic cells with electrical interconnections between the cells, formed on a semiconductor substrate (e.g., silicon). An IC may include a very large number of cells and require complicated connections between the cells. A cell is a group of one or more circuit elements such as transistors, capacitors, resistors, inductors, and other basic circuit elements grouped to perform a logic function. Cell types include, for example, core cells, scan cells and input/output (I/O) cells. Each of the cells of an IC may have one or more pins, each of which in turn may be connected to one or more other pins of the IC by wires. The wires connecting the pins of the IC are also formed on the surface of the chip. For more complex designs, there are typically at least four distinct layers of conducting media available for routing, such as a polysilicon layer and three metal layers (metal-1, metal-2, and metal-3). The polysilicon layer, metal-1, metal-2, and metal-3 are all used for vertical and/or horizontal routing.

An IC chip is fabricated by first conceiving the logical circuit description, and then converting that logical description into a physical description, or geometric layout. This process is usually carried out using a “netlist,” which is a record of all of the nets, or interconnections, between the cell pins, including information about the various components such as transistors, resistors and capacitors. A layout typically consists of a set of planar geometric shapes in several layers. The layout is then checked to ensure that it meets all of the design requirements, particularly timing requirements. The result is a set of design files known as an intermediate form that describes the layout. The design files are then run through a dataprep process that is used to produce patterns called masks by an optical or electron beam pattern generator. During fabrication, these masks are used to etch or deposit features in a silicon wafer in a sequence of photolithographic steps using a complex lens system that shrinks the mask image. The process of converting the specifications of an electrical circuit into such a layout is called the physical design.

Cell placement in semiconductor fabrication involves a determination of where particular cells should optimally (or near-optimally) be located on the surface of a integrated circuit device. Due to the large number of components and the details required by the fabrication process for very large scale integrated (VLSI) devices, physical design is not practical without the aid of computers. As a result, most phases of physical design extensively use computer-aided design (CAD) tools, and many phases have already been partially or fully automated. Automation of the physical design process has increased the level of integration, reduced turn around time and enhanced chip performance. Several different programming languages have been created for electronic design automation (EDA), including Verilog, VHDL and TDML. A typical EDA system receives one or more high level behavioral descriptions of an IC device, and translates this high level design language description into netlists of various levels of abstraction.

Physical synthesis is prominent in the automated design of integrated circuits such as high performance processors and application specific integrated circuits (ASICs). Physical synthesis is the process of concurrently optimizing placement, timing, power consumption, crosstalk effects and the like in an integrated circuit design. This comprehensive approach helps to eliminate iterations between circuit analysis and place-and-route. A generalized physical synthesis flow is shown in FIG. 1. The process begins with an initialization of the circuit design using an input netlist created by an EDA tool (1). The initialization includes general setup tasks such as associating timing and electrical characteristics with various components of the circuit, and identifying nets. Logic cells in the netlist are placed in the available region of the IC chip design using one or more placement tools, e.g., a quadratic optimizer based on total wirelength (2). Once an initial placement is obtained the timing optimization stage performs various transforms such as buffer insertion, gate sizing (repowering), logic re-structuring, etc. to improve the timing characteristics of the design (3). Buffer insertion essentially adds cells to the existing design to introduce known delays. Gate sizing can increase the size of certain cells in the design. In some cases logic re-structuring transforms can also increase the number of cells in the design. After timing optimization and any legalization to resolve overlaps between cells, the process may use various constraints or design parameters to determine whether further placement and optimization are desired (4). If so, the process repeats iteratively at the placement step 2. After all placements and optimizations are complete, routing and other refinements are provided for the circuit (5).

A conventional flow for the optimization step 3 is further illustrated in FIG. 2 and includes three separate optimization stages. The first optimization stage (6) is referred to as fast “timerless” buffering and repowering as exemplified by the electrical violation eliminator (EVE) technique disclosed in U.S. Patent Application Publication No. 2007/0283301. This approach uses an aggressive slew target to achieve good timing results very fast by avoiding expensive timer updates, and can typically optimize 70%-80% of the chip. Using a relaxed slew target with EVE can save area but unacceptably sacrifices timing requirements. After timerless buffering and repowering, critical paths are optimized with a more computationally-intensive timer update analysis (7). Critical paths are generally the set of nets with the most negative slack (the slack of a net is the minimum slack among all slack values for sinks of the net). Optimization using slew-slack histograms is then used to fix any remaining paths having negative slack, i.e., timing violations (8).

Physical synthesis has the ability to repower gates, insert repeaters, clone gates or other combinational logic, etc., so the area of logic in the design remains fluid. However, physical synthesis can take days to complete, and the computational requirements are increasing as designs are ever larger and more gates need to be placed. There are also more chances for bad placements due to limited area resources. As process technology scales to the deep-submicron regime (65 nm and smaller), it becomes particularly difficult to achieve timing targets with efficient use of the chip area for model design closure. Area efficiency is important at different hierarchical levels, e.g., the top level for a large ASIC or at the macro design level, but timing requirements must still be satisfied. Area has traditionally been treated as a constraint (like 80% chip density) and not a design target. Such constraints are generally taken into consideration at the late design stages, for example by performing additional area recovery at the end of a regular physical synthesis flow. This approach has two serious flaws. First, since area is not a target, the final chip design never has the lowest possible achievable area. The increased area may lead to congestion problems, or if the chip area is too large the die size will have to be adjusted, introducing additional expense. Inefficiencies in area also lead to excess power usage. Second, if area is only considered near the end of the design flow, the process can be stalled in the early optimization stage if there are insufficient space tolerances for buffers or repowering. Even if some space is available it is unlikely that the optimization result will be the actual optimal solution. Thus either timing may not be closed, or the flow will require a much longer runtime on iterations and further optimization refinement.

In light of the foregoing, it would be desirable to devise an improved method for physical synthesis flow which could be more area efficient without sacrificing timing and other requirements. It would be further advantageous if there method were achievable with reasonable runtime overhead.

### SUMMARY OF THE INVENTION

It is therefore one object of the present invention to provide an improved method for physical synthesis of an integrated circuit design.

It is another object of the present invention to provide such a method which is particularly area-efficient while satisfying timing requirements.

It is yet another object of the present invention to provide such a method which does not excessively increase the computational requirements in achieving the area efficiency.

The foregoing objects are achieved in a computer-implemented method for optimizing a physical design of an integrated circuit having a plurality of nets, by receiving a layout for a physical placement of the nets, receiving an initial slew constraint, first inserting one or more buffers in the layout such that slew for each of the nets is less than the initial slew constraint, calculating a new slew constraint which is less than the initial slew constraint, and then inserting one or more additional buffers in the layout such that slew for at least one of the nets is less than the new slew constraint. Insertion of additional buffers is iteratively repeated using incrementally decreasing slew constraints until either the current slew constraint is less than or equal to a predetermined minimum slew constraint or none of the nets have negative slack. In the illustrative implementation the next slew constraint is 20%-50% less than the current slew constraint. Any nets having positive slack from the previous iteration are skipped, and that slack information is cached for future timing analysis.

The above as well as additional objectives, features, and advantages of the present invention will become apparent in the following detailed written description.

### BRIEF DESCRIPTION OF THE DRAWINGS

The present invention may be better understood, and its numerous objects, features, and advantages made apparent to those skilled in the art by referencing the accompanying drawings.

FIG. 1 is a chart illustrating the logical flow of a conventional physical synthesis process for an integrated circuit design;

FIG. 2 is a chart illustrating the logical flow for circuit optimization as part of the physical synthesis process of FIG. 1;

FIG. 3 is a block diagram of a computer system programmed to carry out physical synthesis for an integrated circuit design in accordance with one implementation of the present invention;

FIG. 4 is a chart illustrating the logical flow for circuit optimization in accordance with one implementation of the present invention wherein the slew target is repeatedly tightened over multiple iterations of fast timerless buffering and repowering; and

FIGS. 5A-5D are schematic diagrams for nets of an integrated circuit design undergoing optimization in accordance with one implementation of the present invention wherein the slew target is lowered in successive iterations.

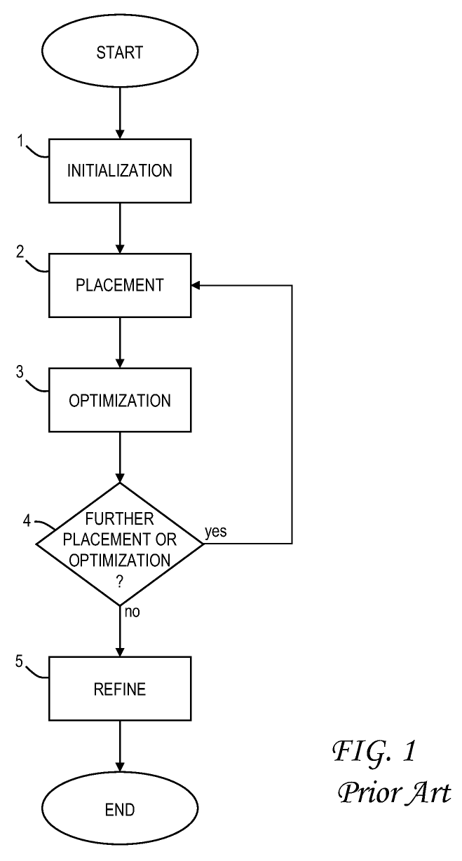

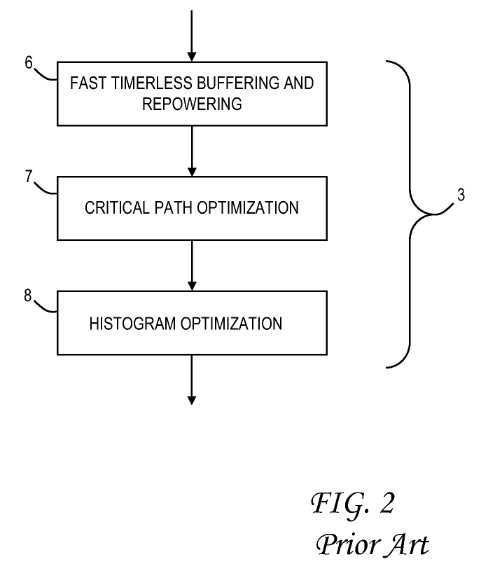

The use of the same reference symbols in different drawings indicates similar or identical items.

### DESCRIPTION OF THE PREFERRED EMBODIMENT(S)

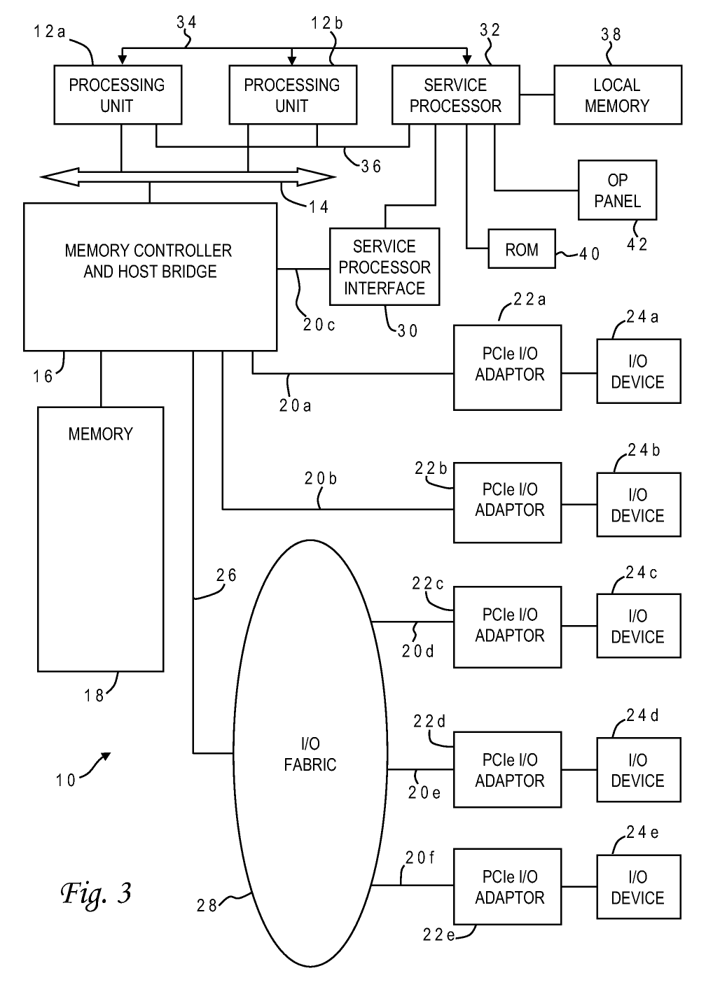

With reference now to the figures, and in particular with reference to FIG. 3, there is depicted one embodiment 10 of a computer system in which the present invention may be implemented to carry out the design of logic structures in an integrated circuit. Computer system 10 is a symmetric multiprocessor (SMP) system having a plurality of processors 12a, 12b connected to a system bus 14. System bus 14 is further connected to a combined memory controller/host bridge (MC/HB) 16 which provides an interface to system memory 18. System memory 18 may be a local memory device or alternatively may include a plurality of distributed memory devices, preferably dynamic random-access memory (DRAM). There may be additional structures in the memory hierarchy which are not depicted, such as on-board (L1) and second-level (L2) or third-level (L3) caches.

MC/HB 16 also has an interface to peripheral component interconnect (PCI) Express links 20a, 20b, 20c. Each PCI Express (PCIe)link 20a, 20b is connected to a respective PCIe adaptor 22a, 22b, and each PCIe adaptor 22a, 22b is connected to a respective input/output (I/O) device 24a, 24b. MC/HB 16 may additionally have an interface to an I/O bus 26 which is connected to a switch (I/O fabric) 28. Switch 28 provides a fan-out for the I/O bus to a plurality of PCI links 20d, 20e, 20f. These PCI links are connected to more PCIe adaptors 22c, 22d, 22e which in turn support more I/O devices 24c, 24d, 24e. The I/O devices may include, without limitation, a keyboard, a graphical pointing device (mouse), a microphone, a display device, speakers, a permanent storage device (hard disk drive) or an array of such storage devices, an optical disk drive, and a network card. Each PCIe adaptor provides an interface between the PCI link and the respective I/O device. MC/HB 16 provides a low latency path through which processors 12a, 12b may access PCI devices mapped anywhere within bus memory or I/O address spaces. MC/HB 16 further provides a high bandwidth path to allow the PCI devices to access memory 18. Switch 28 may provide peer-to-peer communications between different endpoints and this data traffic does not need to be forwarded to MC/HB 16 if it does not involve cache-coherent memory transfers. Switch 28 is shown as a separate logical component but it could be integrated into MC/HB 16.

In this embodiment, PCI link 20c connects MC/HB 16 to a service processor interface 30 to allow communications between I/O device 24a and a service processor 32. Service processor 32 is connected to processors 12a, 12b via a JTAG interface 34, and uses an attention line 36 which interrupts the operation of processors 12a, 12b. Service processor 32 may have its own local memory 38, and is connected to read-only memory (ROM) 40 which stores various program instructions for system startup. Service processor 32 may also have access to a hardware operator panel 42 to provide system status and diagnostic information.

In alternative embodiments computer system 10 may include modifications of these hardware components or their interconnections, or additional components, so the depicted example should not be construed as implying any architectural limitations with respect to the present invention.

When computer system 10 is initially powered up, service processor 32 uses JTAG interface 34 to interrogate the system (host) processors 12a, 12b and MC/HB 16. After completing the interrogation, service processor 32 acquires an inventory and topology for computer system 10. Service processor 32 then executes various tests such as built-in-self-tests (BISTs), basic assurance tests (BATs), and memory tests on the components of computer system 10. Any error information for failures detected during the testing is reported by service processor 32 to operator panel 42. If a valid configuration of system resources is still possible after taking out any components found to be faulty during the testing then computer system 10 is allowed to proceed. Executable code is loaded into memory 18 and service processor 32 releases host processors 12a, 12b for execution of the program code, e.g., an operating system (OS) which is used to launch applications and in particular the circuit design application of the present invention, results of which may be stored in a hard disk drive of the system (an I/O device 24). While host processors 12a, 12b are executing program code, service processor 32 may enter a mode of monitoring and reporting any operating parameters or errors, such as the cooling fan speed and operation, thermal sensors, power supply regulators, and recoverable and non-recoverable errors reported by any of processors 12a, 12b, memory 18, and MC/HB 16. Service processor 32 may take further action based on the type of errors or defined thresholds.

While the illustrative implementation provides program instructions embodying the present invention on disk drive 36, those skilled in the art will appreciate that the invention can be embodied in a program product utilizing other computer-readable media. The program instructions may be written in the C++ programming language for an AIX environment. Computer system 10 carries out program instructions for a physical synthesis process that uses a novel optimization technique to increase area efficiency of an integrated circuit design structure. Accordingly, a program embodying the invention may include conventional aspects of various physical synthesis tools, and these details will become apparent to those skilled in the art upon reference to this disclosure.

In accordance with one implementation of the present invention, computer system 10 performs a circuit optimization which includes fast timerless buffering and repowering, but iteratively repeats this procedure with a changing slew target. Slew (or slew rate) refers to the rise time or fall time of a switching digital signal. Different definitions can be used to quantify slew, the most common being the 10/90 slew which is the time it takes for a waveform to cross from the 10% signal level to the 90% signal level. Other definitions such as 20/80 slew or 30/70 slew are often used when the waveform has a slowly rising or falling tail. Since higher interconnect resistivity causes signal integrity to degrade more quickly with each advancing technology, buffers need to be inserted on long interconnects to meet slew constraints.

FIG. 4 depicts an exemplary optimization process in accordance with the present invention which begins with an initial iteration of fast timerless buffering and repowering using the global slew constraint (50). The global slew constraint will usually depend on the operating frequency for the overall circuit, e.g., for a frequency of 1 gigahertz the global slew constraint (10/90) might be 1 nanosecond. The initial iteration may use a designer-provided slew value other than the global slew. The preferred mode for carrying out fast timerless buffering and powering is the electrical violation eliminator (EVE) technique disclosed in U.S. Patent Application Publication No. 2007/0283301, which is hereby incorporated. That method examines a physical layout of the nets for electrical violations in a sequential order of an output-to-input traversal, and determines a net correction for each of the nets having an electrical violation prior to examining the next net in the sequential order. Violations are corrected by inserting one or more repeaters (buffers or inverters) along the nets in the layout and/or resizing logic gates to meet the slew requirement at each sink of the nets. This procedure does not require stepping through operation of the circuit with timed updates and so is relatively fast (in comparison to timed updating). The invention may alternatively be used with other slew-driven timerless optimization techniques.

After each iteration of fast timerless buffering and repowering, a determination is made as to whether any nets of the circuit have negative slack (52). Slack is the time difference between actual arrival time of a signal and the required arrival time (RAT) according to the circuit design parameters, and is calculated from the input timing characteristics of the net components (e.g., buffers and wire length). Negative slack means the net does not meet the timing requirements, while positive slack indicates timing requirements are met. If computer system 10 determines that all of the nets have positive slack, the timerless buffering and repowering stage is complete, and the process continues with critical path optimization (54) and histogram optimization (56).

If nets with negative slack remain after the current iteration of timerless buffering and repowering, the slew constraint will be incrementally decreased for the next iteration unless it has already been reduced to a minimum (predetermined) slew target for this optimization stage. The value for the minimum slew target should be fairly aggressive, and depends on the particular semiconductor technology, but is preferably the slew for a long optimal buffered line, e.g., 30 picoseconds for 45 nanometer technology for a regular Vₜ threshold buffer on M2 layers. The program instructions running on computer system 10 accordingly compare the current slew constraint to the minimum slew target (57). This comparison could be performed before checking the slack of the nets. If the slew is already at or below the minimum, the timerless buffering and repowering stage is again complete, and the process continues with critical path optimization (54) and histogram optimization (56). If the current slew is not yet at the minimum value, computer system 10 calculates a new slew target (58). However, any nets having positive slack from the previous iteration are skipped to avoid over-optimizing the design structure, and that slack information is cached for future timing analysis. In the illustrative implementation the slew target is incrementally reduced by roughly 20%-50%. The new target may be calculated as a fraction of the current target or by reference to a table of incremental targets. The process then repeats iteratively at box 50 to carry out fast timerless buffering and repowering with the next slew target. Iteratively repeating the fast timerless buffering and repowering while gradually decreasing the slew constraint in this manner results in a design which retains high quality of results with significantly smaller area and wire length.

The entire process of FIG. 4 may further be iteratively repeated as part of a physical synthesis flow which includes conventional placement techniques and refinement. Results of the final optimization are stored in computer system 10 for further processing.

The computation costs associated with the present invention are relatively small. The invention will incur a runtime penalty for the additional iterations with changing slew target, but experiments indicate that significant efficiencies can be obtained with only two to three iterations, in which case the runtime overhead around 5% to 10%. The technique is still much faster than using a fully timer-based optimization methodology.

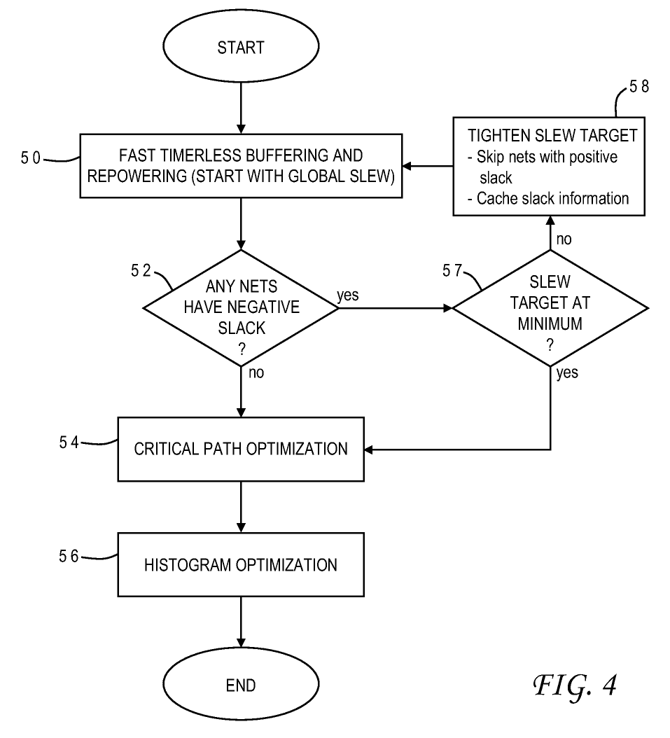

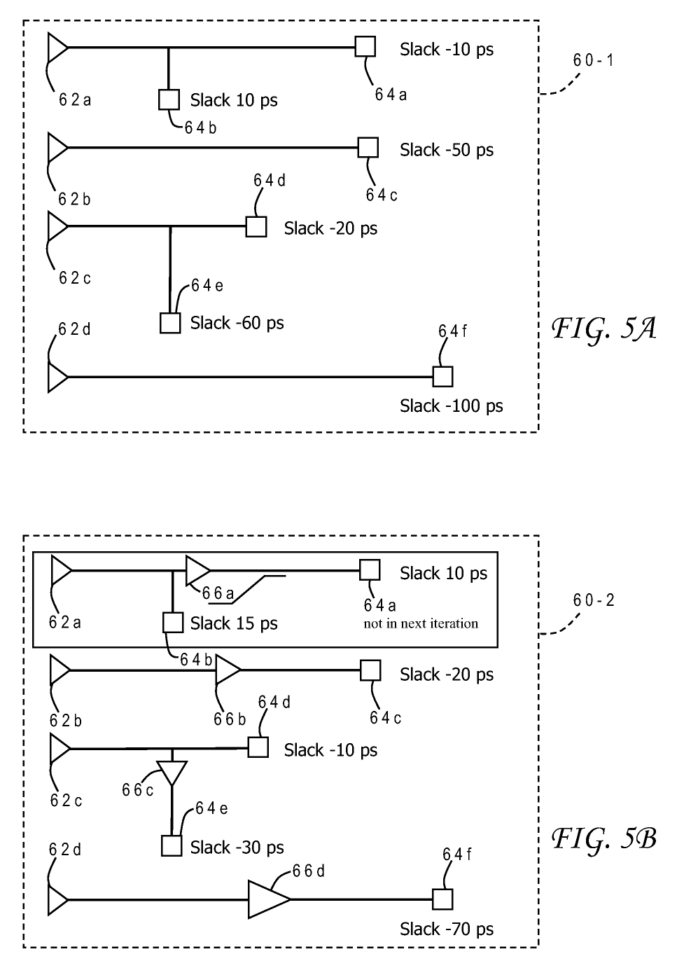

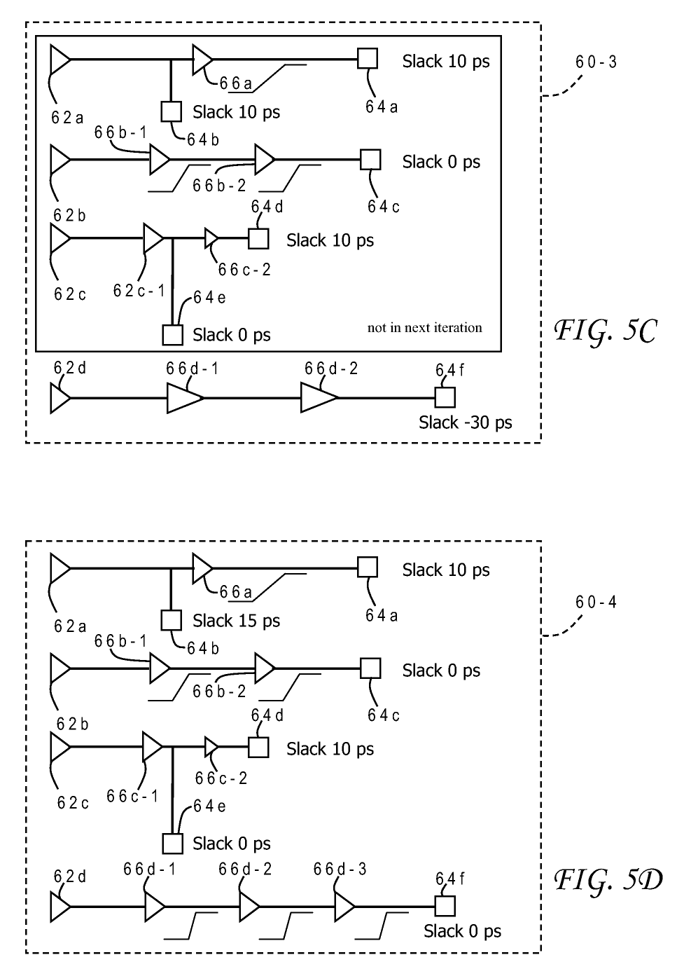

The present invention may be further understood by reference to an exemplary integrated circuit design 60 as shown in FIGS. 5A-5D. In this simplified example integrated circuit design 60 has four nets. The first net includes a source 62a connected to two sinks 64a, 64b; the second net includes a source 62b connected to a sink 64c; the third net includes a source 62c connected to two sinks 64d, 64e; and the fourth net includes a source 62d connected to a sink 64f. The initial design structure 60-1 depicted in FIG. 5A represents a input placement of the sources and sinks. The input placement may be an optimized placement from an EDA tool which receives a netlist of the integrated circuit design, but it can also be a random placement or a custom placement. The input design structure 60-1 has no repeaters (buffers/inverters). Timing analysis based on known electrical characteristics of the wires for input design structure 60-1 calculates a slack of −10 picoseconds at sink 64a, a slack of +10 picoseconds at sink 64b, a slack of −50 picoseconds at sink 64c, a slack of −20 picoseconds at sink 64d, a slack of −60 picoseconds at sink 64e, and a slack of 31 100 picoseconds at sink 64f.

FIG. 5B represents a first iteration of fast timerless buffering and repowering which generates a first optimized design structure 60-2 for the integrated circuit. This iteration uses a global slew value for the circuit of 100 picoseconds, and results in the insertion of a buffer 66a in the first net, a buffer 66b in the second net, a buffer 66c in the third net, and a buffer 66d in the fourth net, in order to conform to the slew target. These buffers may have different sizes as provided in a buffer library; in FIG. 5B buffers 66a, 66b and 66c are medium-sized, while buffer 66d is larger. The specific sizes of the buffers may vary considerably according to the particular application, technology, and buffer insertion method used. The buffers may, for example, have a gate length in the range of 200 nanometers to 3,000 nanometers. Insertion of these buffers increases the slack of the nets: sink 64a has a slack of +10 picoseconds, sink 64b has a slack of +15 picoseconds, sink 64c has a slack of −20 picoseconds, sink 64d has a slack of −10 picoseconds, sink 64e has a slack of −30 picoseconds, and sink 64f has a slack of −70 picoseconds. Since the sinks of the first net in FIG. 5B all have positive slack, the first net is skipped in future iterations of timerless buffering and repowering, and its slack information is cached for further timing analysis.

After this initial round of slew-driven buffering and repowering, the slew target is lowered from 100 picoseconds to 50 picoseconds, and a second round is then performed which generates the second optimized design structure 60-3 for the integrated circuit as seen in FIG. 5C. Because the first net was skipped for this iteration (already having positive slack), it still has buffer 66a with +10 picoseconds slack at sink 64a and +15 picosecond slack at sink 64b as in FIG. 5B. However, additional buffers have been inserted in the other nets in FIG. 5C. The second net now includes buffers 66b-1, 66b-2; the third net now includes buffers 66c-1, 66c-2; and the fourth net now includes buffers 66d-1, 66d-2. Buffer 66c-2 is a smaller buffer size, while buffers 66d-1 and 66d-2 are larger. Insertion of these buffers again increases the slack of the nets: sink 64c has a slack of 0 picoseconds, sink 64d has a slack of +10 picoseconds, sink 64e has a slack of 0 picoseconds, and sink 64f has a slack of −30 picoseconds. Since the sinks of the second and third nets in FIG. 5C all have positive slack, they are also skipped in future iterations of timerless buffering and repowering (in addition to the first net), and their slack information is cached for further timing analysis.

After this second round of slew-driven buffering and repowering the slew target is again lowered, this time from 50 picoseconds to 30 picoseconds, and a third round is then performed which generates the third optimized design structure 60-4 for the integrated circuit as seen in FIG. 5D. Because the first, second and third nets were skipped for this iteration (already having positive slack), they have the same buffers and slack as in FIG. 5C. However, an additional buffer has been inserted in the fourth net in FIG. 5D. The fourth net now includes buffers 66d-1, 66d-2, 66d-3. Insertion of these buffers increases the slack at sink 64f to 0 picoseconds. The different slews for different nets which result from incremental tightening of the slew constraint is reflected in FIG. 5D by the rising signal symbols having different transition times. Since all nets in the third optimized design structure 60-4 have positive slack, the timerless buffering and repowering stage is complete, and the integrated circuit design is then subjected to critical path optimization and histogram optimization.

While the example of FIGS. 5A-5D illustrates only 4 nets and a total of eight inserted buffers, the number of nets in state-of-the-art application-specific integrated circuits (ASICs) is typically in the thousands, with the insertion of as many as 500,000 buffers. The efficiencies of the present invention are accordingly even more significant at this scale. In experiments with the design of 65 nm ASIC macros, the invention saw an average savings of 4.7% in area and 5% in wirelength, while retaining high quality of results (QOR). For some macros, the QOR actually improved as better area usage often leads to better timing results. The present invention thus increases efficiency without sacrificing other targets, and with fast turn-around time.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. It is therefore contemplated that such modifications can be made without departing from the spirit or scope of the present invention as defined in the appended claims.

What is claimed is:

1. A computer-implemented method for optimizing a physical design of an integrated circuit having a plurality of nets, the method comprising:
receiving a layout for a physical placement of the nets;
receiving an initial slew constraint;
first inserting one or more buffers in the layout such that slew for each of the nets is less than the initial slew constraint;
calculating a new slew constraint which is less than the initial slew constraint; and
second inserting one or more additional buffers in the layout such that slew for at least one of the nets is less than the new slew constraint.

2. The method of claim 1 wherein the new slew constraint is 20%-50% less than the initial slew constraint.

3. The method of claim 1 wherein said second inserting of one or more additional buffers is iteratively repeated using incrementally decreasing slew constraints until either a current slew constraint is less than or equal to a predetermined minimum slew constraint or none of the nets have negative slack.

4. The method of claim 1 wherein the one or more additional buffers are inserted only in a first set of nets having negative slack after said first inserting.

5. The method of claim 4 wherein slack information for a second set of nets having non-negative slack after said first inserting is cached for further timing analysis.

6. A computer system comprising:
one or more processors which process program instructions;
a memory device connected to said one or more processors; and
program instructions residing in said memory device for optimizing a physical design of an integrated circuit having a plurality of nets, by receiving a layout for a physical placement of the nets, receiving an initial slew constraint, first inserting one or more buffers in the layout such that slew for each of the nets is less than the initial slew constraint, calculating a new slew constraint which is less than the initial slew constraint, and second inserting one or more additional buffers in the layout such that slew for at least one of the nets is less than the new slew constraint.

7. The computer system of claim 6 wherein the new slew constraint is 20%-50% less than the initial slew constraint.

8. The computer system of claim 6 wherein said program instructions iteratively repeat the second inserting of one or more additional buffers using incrementally decreasing slew constraints until either a current slew constraint is less than or equal to a predetermined minimum slew constraint or none of the nets have negative slack.

9. The computer system of claim 6 wherein said program instructions insert the one or more additional buffers only in a first set of nets having negative slack after the first inserting.

10. The computer system of claim 9 wherein said program instructions cache slack information for a second set of nets having non-negative slack after the first inserting for further timing analysis.

11. A computer program product comprising:
a computer-readable medium; and
program instructions residing in said medium for optimizing a physical design of an integrated circuit having a plurality of nets, by receiving a layout for a physical placement of the nets, receiving an initial slew constraint, first inserting one or more buffers in the layout such that slew for each of the nets is less than the initial slew constraint, calculating a new slew constraint which is less than the initial slew constraint, and second inserting one or more additional buffers in the layout such that slew for at least one of the nets is less than the new slew constraint.

12. The computer program product of claim 11 wherein the new slew constraint is 20%-50% less than the initial slew constraint.

13. The computer program product of claim 11 wherein said program instructions iteratively repeat the second inserting of one or more additional buffers using incrementally decreasing slew constraints until either a current slew constraint is less than or equal to a predetermined minimum slew constraint or none of the nets have negative slack.

14. The computer program product of claim 11 wherein said program instructions insert the one or more additional buffers only in a first set of nets having negative slack after the first inserting.

15. The computer program product of claim 14 wherein said program instructions cache slack information for a second set of nets having non-negative slack after the first inserting for further timing analysis.

16. A design structure embodied in a computer-readable medium used in the design of an integrated circuit, the design structure comprising:
a plurality of nets each having a source and at least one sink, said sources and sinks being placed in a layout with interconnecting wires;
a first plurality of buffers inserted in the layout such that slew for each of said nets is less than a first slew constraint; and
at least one additional buffer inserted in the layout such that slew for at least one of said nets is less than a second slew constraint, wherein the second slew constraint is less than the first slew constraint.

17. The design structure of claim 16 wherein the second slew constraint is 20%-50% less than the first slew constraint.

18. The design structure of claim 16 further comprising at least one other additional buffer inserted in the layout such that slew for at least a second one of said nets is less than a third slew constraint, wherein the third slew constraint is less than the second slew constraint.

19. The design structure of claim 16 wherein said at least one additional buffer is inserted in one of a first set of said nets which would have negative slack without said at least one additional buffer.

20. The design structure of claim 16 wherein none of the nets have negative slack.
